(19) United States
(12) Patent Application Publication
(10) Pub. No.: US 2010/0329975 A1
(43) Pub. Date: Dec. 30, 2010

(54) Cordierite-Forming Compositions With Hydratable Alumina And Methods Therefor

(76) Inventors: William Peter Addiego, Big Flats, NY (US); Kevin Robert Brundage, Corning, NY (US); Christopher Raymond Glose, Painted Post, NY (US); Thomas Edward Paulson, Groveland, IL (US); Patrick David Tepesch, Corning, NY (US)

Correspondence Address: CORNING INCORPORATED, SP-TI-3-1, CORNING, NY, 14831, US

(21) Appl. No.: 12/493,663

(22) Filed: Jun. 29, 2009

(51) Int. Cl. C01B 39/02

(52) U.S. Cl. 423/700

(57) ABSTRACT

A cordierite batch composition that includes a hydratable alumina, as defined herein. The hydratable alumina, when hydrated, can provide additional strength to shaped batch compositions at temperatures below those used to fire the compositions. Methods are also provided for forming cordierite ceramic articles from the cordierite batch compositions.

The entire disclosure of any publication, patent, or patent document mentioned herein is incorporated by reference.

### FIELD

The present disclosure relates generally to cordierite compositions for forming ceramic articles, and particularly to cordierite compositions comprising hydratable alumina for forming ceramic engine exhaust treatment articles.

### BACKGROUND

Porous ceramic articles such as porous ceramic particulate filters and ceramic catalytic supports or substrates, which can be made having, for example, a honeycomb structure, can serve in exhaust gas treatment systems.

### SUMMARY

In embodiments, the disclosure provides a cordierite batch composition comprising inorganic cordierite-forming ingredients comprising a hydratable alumina in an amount of from greater than about 0.1 wt % to about 50 wt % based on the total weight of the inorganic cordierite-forming ingredients. The hydratable alumina can comprise at least one of rho-alumina, gamma-alumina, eta-alumina, delta-alumina, kappa-alumina, or combinations thereof. The hydratable alumina, when hydrated, provides a binder system that increases the strength of the composition at low temperatures.

In embodiments, the disclosure provides a method for producing a cordierite ceramic article comprising mixing the inorganic cordierite-forming ingredients with a binder and a solvent to form a batch, forming the batch into a green body, drying the green body at a first time and temperature and then at a second temperature, and firing the at least partially dried green body to produce the article. The first drying time and temperature can be, for example, less than about 60 minutes and at least less than about 100° C., respectively, and the second drying temperature can be at from about 200° C. to about 1,200° C. until the green body is from about 70% to about 80% dry.

In embodiments, the disclosure provides a method of producing a porous cordierite ceramic article comprising mixing the inorganic cordierite-forming ingredients with a binder and a solvent to form a batch, forming the batch into a green body, drying the green body with an electromagnetic device for a time and with a power sufficient to cause the hydration of the hydratable alumina by the solvent, and firing the dried green body to produce the article. The electromagnetic device can be, for example, a microwave and the power can be, for example, less than about 100 kW for a time of about less than 6 hours.

Additional embodiments of the disclosure are set forth in the detailed description, and in part will be readily apparent to those skilled in the art from that description or recognized by practicing the disclosure, including the claims, and any appended drawings.

The foregoing general description and the detailed description present embodiments intended to provide an overview or framework for understanding the claimed invention.

### BRIEF DESCRIPTION OF THE DRAWINGS

In embodiments of the disclosure:

FIG. 1 is a plot showing the effect of hydration time of cordierite compositions comprising hydratable alumina on the compression strength;

FIG. 2 is a plot showing the effect of hydration conditions of cordierite compositions comprising hydratable alumina on the modulus of rupture (MOR);

FIG. 3 is a plot showing the effect of hydration conditions on the physical properties of cordierite compositions comprising hydratable alumina;

FIG. 4 is a plot showing the relationship between the power and time of microwave drying on the modulus of rupture (MOR) of hydration conditions of cordierite compositions comprising hydratable alumina;

FIG. 5 is table of physical properties of various cordierite compositions comprising a hydratable alumina;

FIG. 6 is a dilatometry plot showing the effect of increasing temperature on green honeycomb bodies of ceramic-forming composition comprising hydratable alumina; and

FIG. 7 is a plot illustrating the impact of increasing amounts of hydratable alumina in cordierite-forming compositions on delta T during firing.

### DETAILED DESCRIPTION

In embodiments, the disclosure provides cordierite batch compositions comprising inorganic cordierite-forming ingredients comprising a hydratable alumina. The hydratable alumina can replace all the alumina compounds in the cordierite-forming ingredients or the hydratable alumina can partially replace some of the alpha-alumina or aluminum trihydrate that are typically part of the cordierite-forming ingredients. The addition of the hydratable alumina can result in a cordierite composition having intermediate firing strength between about 200° C. to about 1,200° C., reduce temperature gradients within large dimensional cordierite substrates greater than about 10 cm diameter and greater than about 15 cm long, and reduce or eliminate cracking during firing.

Although not bound by theory, the hydratable alumina is believed to form hydroxylated structures capable of hydrogen bonding with other oxides and yields an oxide binder network upon elimination of water during drying. When mixed with aqueous solvents, hydratable alumina hydrolyzes to form hydroxylated structures that can couple with oxides to form hydrogen bonds. The strength and other characteristics imparted during firing of the cordierite batch compositions of the disclosure can result from binder hydration network formation of, for example, —Al—O—Al—OH . . . O—Al— and hydrogen bonding with other oxide species in the composition. Such bonding can also provide cohesive strength and structural integrity to the green body prior to sintering. In contrast, without the hydratable alumina present less robust forces hold the composition together before sintering.

“Include,” “includes,” or like terms means encompassing but not limited to, that is, inclusive and not exclusive.

An advantage of the addition of an activated transition alumina provides a variety of improved processing characteristics, including for example, the elimination of low-temperature shrinkage during firing that decreases stress, provides intermediate monolith strength, minimizes the change in temperature (ΔT) during firing, and reduces or eliminates cracking in fired parts. In addition, improving the thermo-mechanical integrity of the monoliths during firing can shorten firing schedules. This was unexpected since compositions comprising hydratable alumina normally have a high amount of shrinkage. In contrast to the present disclosure, known compositions comprising almost all hydratable alumina shrink about 20-25% and need special drying conditions, i.e., drying slowly under controlled humidity, to reduce or prevent cracking of a finished ceramic article. Other options to control shrinkage include, for example, the addition of bulk fillers such as foams. With cordierite compositions of the disclosure, shrinkage can be minimized and avoid the special conditions required of known compositions.

We have found that green bodies that are fired to form cordierite containing ceramic articles are ordinarily weak during firing as the organic binder, such as a methylcellulose, burns out before the batch composition, i.e., alumina, talc, magnesium oxide, silica, or combinations thereof, react to form the cordierite phase. Formation of the cordierite phase normally occurs at temperatures greater than about 1,200° C. and usually by about 1,400° C. to about 1,425° C. Within the temperature range where cordierite is the weakest, from about 200° C. to about 1,200° C., the substrate experiences stresses due to volume changes, thermal gradients, and phase transitions that can cause cracking, especially in large dimensional parts. There is also the potential for variation in the final physical properties of the substrate, such as porosity and median pore size. The materials ordinarily batched to form cordierite, such as alpha alumina and quartz, are generally chemically inert with little surface area or activated surface chemistry. Talc, magnesium oxide, or hydroxide are not inert, but do not create an inorganic binder network throughout the substrate during firing temperatures between about 200° C. to about 1,200° C. There are also dimensional changes that occur in the substrate or their consequential stresses that result in cracking, poor strength, or variation in the physical properties of the ceramic substrates.

In embodiments, the disclosure provides a more robust cordierite batch composition resulting in a green body having increased strength before and throughout the firing process, reduced cracking and variation in physical properties, and increased strength when fired into a ceramic substrate article.

In embodiments the disclosure provides a cordierite batch composition comprising inorganic cordierite-forming ingredients that comprise a hydratable alumina. The hydratable alumina can be, for example, rho-alumina, gamma-alumina, eta-alumina, delta-alumina, kappa-alumina, or a combination thereof. The hydratable alumina can form a binder hydration network of —Al—O—Al—OH . . . O—Al— and hydrogen bonds with other oxide species in the composition.

In embodiments, the hydratable alumina can be present in an amount of, for example, from greater than about 0.1 wt % to about 50 wt % based on the total weight of the inorganic cordierite-forming ingredients. Greater amounts of hydratable alumina can lead to increased shrinkage with drying of the composition, and result in decreased strength and an increase in cracks formed. Unless otherwise noted herein, “cracks” or “cracking” refers to “macrocracks.” Cracks can result in the rejection or failure of a ceramic article in contrast to “microcracks” which may be desirably present in the microstructure of the ceramic article. In embodiments, the hydratable alumina can be present in an amount of, for example, from about 1 wt % to about 50 wt %, from about 1 wt % to about 40 wt %, from about 5 wt % to about 35 wt %, from about 10 wt % to about 35 wt %, from about 10 wt % to about 30 wt %, from about 15 wt % to about 30 wt %, from about 20 wt % to about 30 wt %, or like amounts, including intermediate values and ranges. Inorganic cordierite-forming ingredients normally comprise a form of alumina such as alpha-alumina, aluminum trihydrate, or combinations thereof. The hydratable alumina of the disclosure may replace all or part of the alpha-alumina, aluminum trihydrate, or both. In embodiments the inorganic cordierite-forming ingredients can comprise a mixture of from about 10 wt % to about 30 wt % hydratable alumina, or like amounts defined above, and from about 30 wt % to about 10 wt % of alpha-alumina, aluminum trihydrate, or combinations thereof. In embodiments, the inorganic cordierite-forming ingredients can comprise from about 10 wt % to about 30 wt % of hydratable alumina or like amounts defined above, and alpha-alumina, aluminum trihydrate, or combinations thereof, where the total amount of alumina species (hydratable alumina, alpha-alumina, aluminum trihydrate, or combinations thereof) is from about 0.1 wt % to about 50 wt % based on the total weight of the inorganic cordierite-forming ingredients.

The cordierite batch compositions of the disclosure may further include other known cordierite-forming ingredients. Some exemplary ceramic batch material compositions for forming cordierite are disclosed, for example, in U.S. Pat. Nos. 3,885,977; RE 38,888; 6,368,992; 6,319,870; 6,214,437; 6,210,626; 5,183,608; 5,258,150; 6,432,856; 6,773,657; 6,864,198, 7,141,089, and 7,179,316.

The inorganic cordierite-forming ingredients can be mixed together with a binder and a solvent to form a precursor batch. The solvent may hydrate the hydratable alumina, forming a binder network as described above. The solvent can also provide a medium for the binder to dissolve in, thus providing plasticity to the batch and wetting of the powders. The solvent can be aqueous-based, which may normally be water or water-miscible solvents, organic-based solvents, or mixtures thereof. Most useful are aqueous-based solvents which provide hydration of the hydratable alumina and the binder. Typically, the amount of aqueous solvent can be, for example, from about 20% to about 50% by weight, including intermediate values and ranges.

The binder can be any known binder for producing ceramic articles. In embodiments, the binder can be a cellulose ether binder such as methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxymethylcellulose, and like binders, or a mixture thereof.

The properties of preferred cellulose-based binders, such as methylcellulose, can be, for example, water retention, water solubility, surface activity or wetting ability, thickening of the mixture, providing wet and dry green strength to the green bodies, thermal gelation and hydrophobic association in an aqueous environment. Cellulose ether binders that promote hydrogen bonding interaction with the solvent can be desirable. Examples of substituent groups that maximize the hydrogen bonding interaction with polar solvents, for example, water, can be hydroxypropyl and hydroxyethyl groups, and to a lesser extent hydroxybutyl groups.

In embodiments, other additives, such as surfactants and oil lubricants, can be added to the inorganic cordierite-forming ingredients so long as they do not cause decomposition of or otherwise interfere with the optional pore forming agent while forming the green body. Examples of surfactants can include C₈ to C₂₂ fatty acids, and like materials and derivatives thereof. Additional surfactant components that can be used with these fatty acids include, for example, C₈₋₂₂ fatty esters, C₈₋₂₂ fatty alcohols, and like materials, or combinations of these. Exemplary surfactants include, for example, stearic, lauric, oleic, linoleic, palmitoleic acids, and their derivatives, stearic acid alone or in combination with ammonium lauryl sulfate, and a combination thereof. In embodiments, the surfactant can be lauric acid, stearic acid, oleic acid, and combinations of these. The amount of surfactant(s) can be, for example, from about 0.5% to about 2% by weight of the total weight of the batch.

Examples of oil lubricants can be light mineral oil, corn oil, high molecular weight polybutenes, polyol esters, a blend of light mineral oil and wax emulsion, a blend of paraffin wax in corn oil, and combinations of these. Typically, the amount of oil lubricants can be, for example, from about 1% to about 10% by weight. In embodiments, the oil lubricants can be, for example, present from about 3% to about 6% by weight of the total weight of the batch.

In embodiments, conventional pore formers can also be included in the inorganic ceramic-forming ingredients. Conventional pore formers can typically be any particulate substance that “burns out” of the formed green body during firing. This can include any fugitive particulate material which, for example, evaporates or undergoes vaporization by combustion during drying or heating of the green body to further obtain a desired, usually larger porosity, coarser median pore diameter, or both, than would otherwise be obtained. Exemplary optional burnout agents that can be used include organics that are solid at room temperature, elemental carbon, graphite, cellulose, a sugar, flour, a starch, and like organics. Conventional pore formers can be present in the precursor batch composition at up to about 80 wt %.

In embodiments, the precursor batch can be formed into a green body by any suitable ceramic forming process, for example, extrusion, injection molding, slip casting, centrifugal casting, pressure casting, dry pressing, and like processes prior to any substantial decomposition of the pore forming agent and subsequent pore forming gas evolution. In embodiments, extrusion can be accomplished using, for example, a hydraulic ram extrusion press, a two stage de-airing single auger extruder, a twin screw mixer with a die assembly attached to the discharge end, and like apparatus. In a twin screw mixer, the proper screw elements can be selected according to material and other process conditions to build up sufficient pressure to force the batch material through the die.

The green bodies of the disclosure can have any convenient size and shape and the disclosure is applicable to all processes in which plastic powder mixtures are shaped. The process can be especially suited to production of cellular monolith bodies such as honeycombs. Cellular bodies have applications such as in catalysis, adsorption, electrically heated catalysts, filters such as diesel particulate filters, molten metal filters, regenerator cores, and like articles and applications.

Generally honeycomb densities can be, for example, from about 235 cells/cm² (1,500 cells/in²) to about 15 cells/cm² (100 cells/in²). Examples of honeycombs produced by the process of the disclosure can be those having about 94 cells/cm² (about 600 cells/in²), or about 62 cells/cm² (about 400 cells/ in²) each having wall thicknesses of about 0.1 mm (4 mils). Typical wall thicknesses can be from about 0.07 to about 0.6 mm (about 3 to about 25 mils), although thicknesses of about 0.02-0.048 mm (1-2 mils) can be possible with better equipment. The method can be especially suited for extruding thin wall/high cell density honeycombs. Although a honeycomb ceramic filter of the disclosure normally can have a structure in which a plurality of through holes opened to the end surface of the exhaust gas flow-in side and to the end surface of the exhaust gas flow-out side are alternately sealed at both the end surfaces, the shape of the honeycomb filter is not particularly restricted. For example, the filter can be a cylinder having end surfaces with a shape of a circle or an ellipse, a prism having the end surfaces with a shape of a polygon such as a triangle or a square, a shape in which the sides of these cylinder and prism are bent like a “doglegged” shape, or like geometries and combinations. In addition, the shape of through holes is not particularly limited. For example, the sectional shape can be a polygon, such as a square, a hexagon, an octagon, a circle, an ellipse, a triangle, or other like shapes and combinations. The particular desired size and shape of the ceramic article can depend on the application, e.g., in automotive applications by engine size and space available for mounting, and like considerations.

The formed green body having a desired size and shape can then be dried to remove excess moisture. Additionally, the drying step can also hydrate the hydratable alumina resulting in the formation of the alumina binder system. Alternatively, a wet-aging step can precede the drying step, which allows the hydration of the hydratable alumina prior to drying. The wet-aging step can optionally precede the formation of the green body.

In embodiments, the cordierite batch composition or the green body can be wet-aged to hydrate the hydratable alumina. The cordierite batch composition or green body can be wet-aged for up to, for example, about 160 hours at a temperature from about ambient temperature to about 100° C. In embodiments, the cordierite batch composition or green body can be wet-aged from about 30 minutes to about 24 hours. In embodiments, the cordierite batch composition or green body can be wet-aged at a temperature of, for example, from about 50° C. to about 100° C.

In embodiments, the green body can be dried at a first time and a first temperature that allows for the hydration of the hydratable alumina. By controlling the conditions at which drying occurs, the hydratable alumina can be hydrated without an additional step. The conditions for drying can be such that the drying is at a controlled rate, allowing for hydration of the alumina before significant amounts of solvent or water are lost. In embodiments, the green body can be dried, for example, in less than about 60 minutes at less than 100° C. Drying can be accomplished by any method or device that provides the desired temperature, including, for example, radiant heat. Alternatively, the green body can be dried using an electromagnetic device such as a microwave oven at low power for a sufficient amount of time. When using a microwave oven, the green body can be dried at low power of, for example, less than about 100 kW. In embodiments, the green body can be dried at, for example, less than about 50 kW or, alternatively, at from about 2 kW to about 25 kW. The green body can be dried at low power for less than about 6 hours, or alternatively, for less than about 1 hour. For example, the green body can be dried at low temperature for from about 1 minute to about 60 minutes, or alternatively, for about 1 minute to about 40 minutes.

In embodiments, it can be desirable to further dry the green body at a second temperature or power to a desired dryness, for example, from about 70% to 80% dry, before firing the green body. In embodiments, the second temperature can be from about 200° C. to about 1,200° C. Alternatively, the microwave power can be from about 100 kW and greater. The green body can be dried by ramping up the temperature or power until the desired dryness is achieved. There can be a continuous increase in temperature or power. Alternatively, the temperature or power can be increased in a step-wise fashion.

Once dried, the green body can be fired under conditions effective to convert the green body into a ceramic article comprising a primary crystalline phase ceramic composition. The effective firing conditions can vary depending on the process conditions, for example, the specific composition, size, shape, or like aspects of the green body, and nature of the equipment used. In embodiments, the optimal firing conditions can to be adapted for very large cordierite structures, i.e., slowed down, for example. However, in embodiments, for mixtures that are primarily for forming cordierite, the firing conditions can comprise heating the green body to a maximum soak temperature of about 1,350° C. to about 1,450° C. In embodiments, the green body can be fired at a soak temperature of from about 1,400° C. to about 1,450° C. In embodiments, the green body can be fired at a soak temperature of from about 1,415° C. to about 1,435° C., including a preferred soak temperature, for example, of about 1,420° C. to about 1,430° C.

The firing times can be, for example, from about 40 to about 250 hours, during which a maximum soak temperature can be reached and held for a soak time of from about 5 hours to about 50 hours, more preferably between about 10 hours to about 40 hours. The soak time can be from about 15 hours to about 30 hours. A preferred firing schedule includes firing at a soak temperature of from about 1,415° C. to 1,435° C. for about 10 hours to about 35 hours.

### EXAMPLES

The following examples serve to more fully describe the manner of making and using the above-described disclosure, and to set forth examples of the best modes contemplated for carrying out various aspects of the disclosure. It is understood that these examples do not limit the scope of this disclosure, but rather are presented for illustrative purposes.

### Example 1

### Effect of the Addition of Hydratable Alumina on Cordierite Compositions

The base cordierite composition was composed of approximately 40 wt % talc, 22 wt % alpha-alumina, 16 wt % aluminum trihydrate, and 22% Cerasil 300 quartz (TYO). Compositions can also contain up to 20 wt % of a pore former such as graphite, starch, or like combinations. The hydratable alumina, CP5, commercially available from Alcoa®, is an x-ray amorphous alumina made by the flash-calcination of aluminum trihydrate, Al(OH)₃, and quenched to less than 300° C. before it had time to develop a crystal phase. As a highly dehydrated alumina, with less than 6 wt % loss on ignition (LOI), CP5 readily hydrated in water to yield active hydroxyls capable of forming a binder-like network. The CP5 was substituted for the alpha-alumina, the aluminum trihydrate, or both, in the compositions.

Table 1 shows the impact of CP5 addition to the TYO composition in extruded monoliths. The calcination temperature used to determine the intermediate strength was 800° C. for 30 minutes. Even though the median particle size of CP5 was about 5 to about 7 microns, the porosity of the resulting monoliths with the addition of 20 wt % CP5 was excellent. There was an overall coarseness to the pore size, median size greater than 20 microns, that was desirable, as shown by the (d₅₀−d₁₀)/d₅₀ values in the last column. For comparison, the TYO base composition exhibited no measurable strength when calcined at 800° C. for 30 min, and the A-axis compression was assumed to be less than 5 psi. Compression strength after calcination at 800° C. increased proportionately with increasing hydration time which allowed the batch water in the green, undried honeycomb to hydrate the alumina.

TABLE 1

| | | A-axis | | | | | | | |
|---|---|---|---|---|---|---|---|---|---|
| Change | | compression | | Porosity | | | | | |
| to TYO- | Hydration | (psi) | | | Vol. | d₅₀ | d₁₀ | d₉₀ | d₅₀ − d₁₀ |
| base | Time (hr) | 800° C. | 1415° C. | % Porosity | (cc/g) | (μm) | (μm) | (μm) | d₅₀ |
| 5% CP5 | 0 | 0 | 2143 | 48.67 | 0.37 | 23.90 | 18.32 | 41.51 | 0.234 |
| | 3 | 0 | 1817 | 48.67 | 0.37 | 24.45 | 18.98 | 42.17 | 0.224 |
| | 6 | 0 | 1635 | 49.07 | 0.38 | 22.63 | 16.99 | 39.15 | 0.249 |
| | 24 | 15 | 2274 | 50.39 | 0.36 | 22.26 | 16.74 | 38.11 | 0.248 |
| | 30 | 17 | 1850 | 48.39 | 0.37 | 22.22 | 16.29 | 39.75 | 0.267 |
| | 145 | 15 | 1785 | 49.16 | 0.38 | 22.46 | 16.68 | 38.51 | 0.257 |
| 10% CP5 | 0 | 0 | 1774 | 48.56 | 0.38 | 25.77 | 19.88 | 48.38 | 0.228 |
| | 3 | 21 | 1977 | 47.54 | 0.37 | 23.09 | 17.24 | 40.79 | 0.253 |
| | 6 | 35 | 1882 | 46.57 | 0.36 | 23.18 | 17.34 | 40.69 | 0.252 |
| | 24 | 52 | 2229 | 48.48 | 0.36 | 22.16 | 16.42 | 38.73 | 0.259 |
| | 30 | 51 | 1603 | 49.03 | 0.37 | 21.93 | 16.32 | 38.11 | 0.256 |
| | 145 | 76 | 2093 | 47.09 | 0.35 | 22.74 | 16.88 | 39.61 | 0.258 |
| 20% CP5 | 0 | 0 | 1251 | 48.59 | 0.39 | 29.00 | 22.63 | 53.09 | 0.220 |
| | 3 | 52 | 1414 | 50.84 | 0.39 | 26.07 | 19.43 | 47.74 | 0.254 |
| | 6.5 | 80 | 1581 | 49.17 | 0.38 | 24.60 | 18.04 | 44.91 | 0.267 |
| | 24 | 87 | 1461 | 48.97 | 0.38 | 25.40 | 18.56 | 46.46 | 0.269 |
| | 30 | 102 | 1543 | 47.87 | 0.37 | 24.74 | 18.59 | 43.48 | 0.248 |
| | 145 | 155 | 1516 | 46.81 | 0.37 | 23.05 | 16.67 | 40.82 | 0.277 |

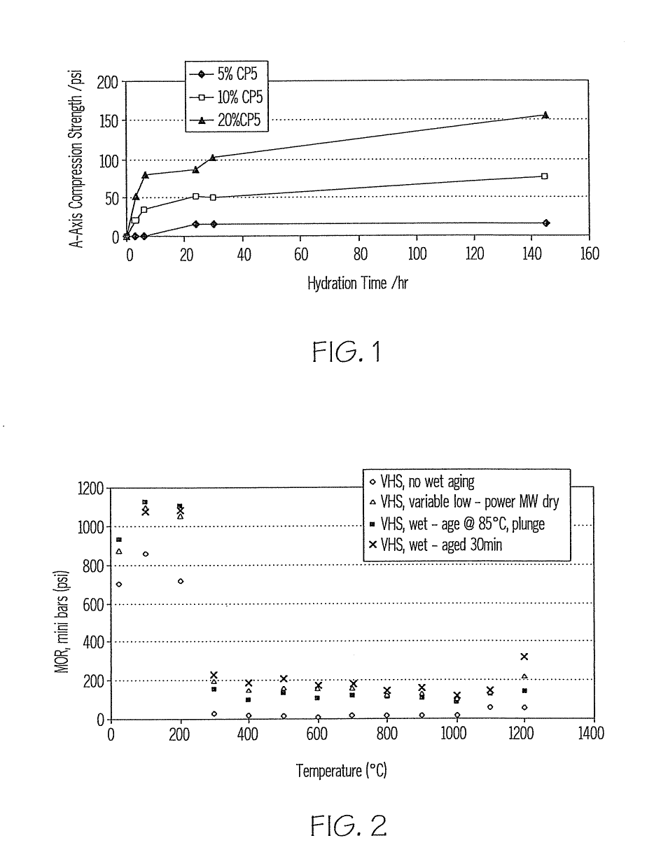

Referring to the Figures, the FIG. 1 graph shows the improvement in strength with hydration time and CP5 concentration. Higher concentrations of CP5 increased intermediate firing strength, especially after short hydration times. Significant strength is obtained after relatively short hydration times with CP5 concentrations of 10 wt % and 20 wt %, suggesting that with further improved drying technique, the hydration kinetics of alumina could be increased in the cordierite batch composition, allowing parts to develop strength with microwave drying and subsequent firing.

### Example 2

### Effect of the Hydration and Calcining Conditions

Compositions with CP5 were scaled to full-size substrates. These substrates were observed for cracks and tested for physical properties. It was found that compositions with 20 wt % CP5 provided excellent properties and processing characteristics, and that concentrations greater than or equal to 10 wt % CP5 also provided better performance than the base TYO composition. The graph in FIG. 2 shows the MOR of mini-bars of extruded compositions comprising 20 wt % CP5 with different hydration, or aging, conditions, and calcined at different temperatures (x-axis). All compositions showed extraordinarily high green strength and strength obtained after calcination at less than 200° C., increasing with hydration. With low-power microwave heating, the composition was shown to develop significant strength, similar to the compositions dried at 85° C. As shown with the previous samples, compositions that were not allowed to hydrate exhibited no significant strength after calcination above 200° C. while hydration significantly increased strength.

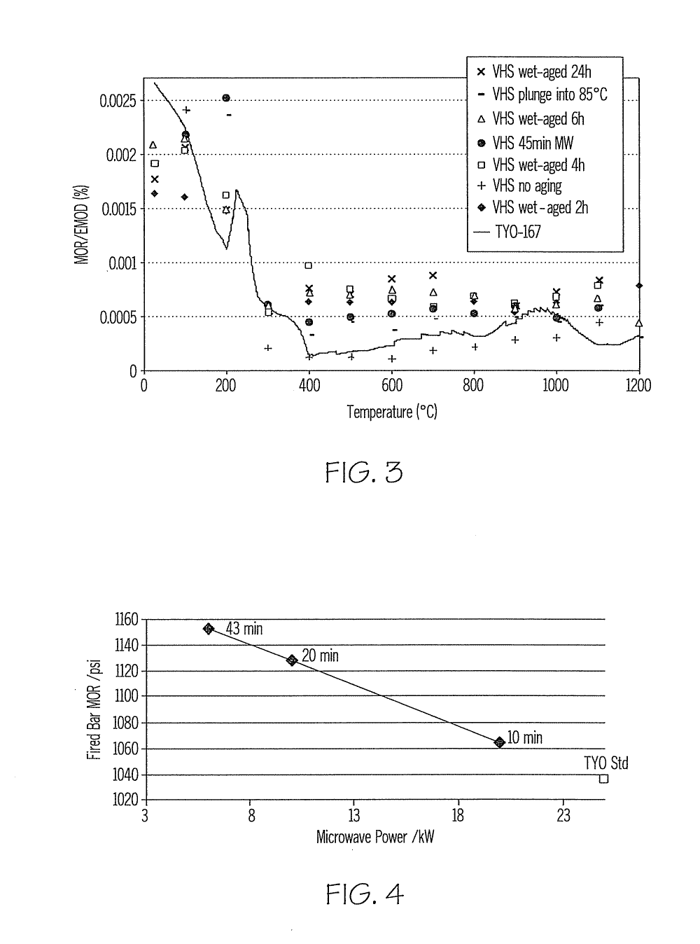

FIG. 3 shows the effect of the drying process, during which hydration occurred, on intermediate temperature strain tolerance as measured by the MOR/E-Mod and calcined at different temperatures (x-axis). All sample compositions comprised 20 wt % CP5 except the standard TYO control composition. In FIG. 3, the strain tolerance of hydrated compositions with CP5 was superior to the standard composition (TYO) and the sample without hydration (no aging). In general, the strength of the CP5 composition was higher than that of the TYO base composition. The improved thermo-mechanical properties resulted in a better quality part and higher selects.

It was also observed that the presence of CP5 essentially eliminated cracking in large dimension cordierite honeycombs. The essentially crack-free parts were observed for various drying conditions in 5.66 inch diameter 200 cpsi 18 mil web monolith samples containing 20% CP5 as compared to the TYO standard. Both microwave and hot air drying (radiant heat) conditions were evaluated and the resulting dried parts were found to be essentially crack-free.

### Example 3

### Effect of Low Power Microwave Drying

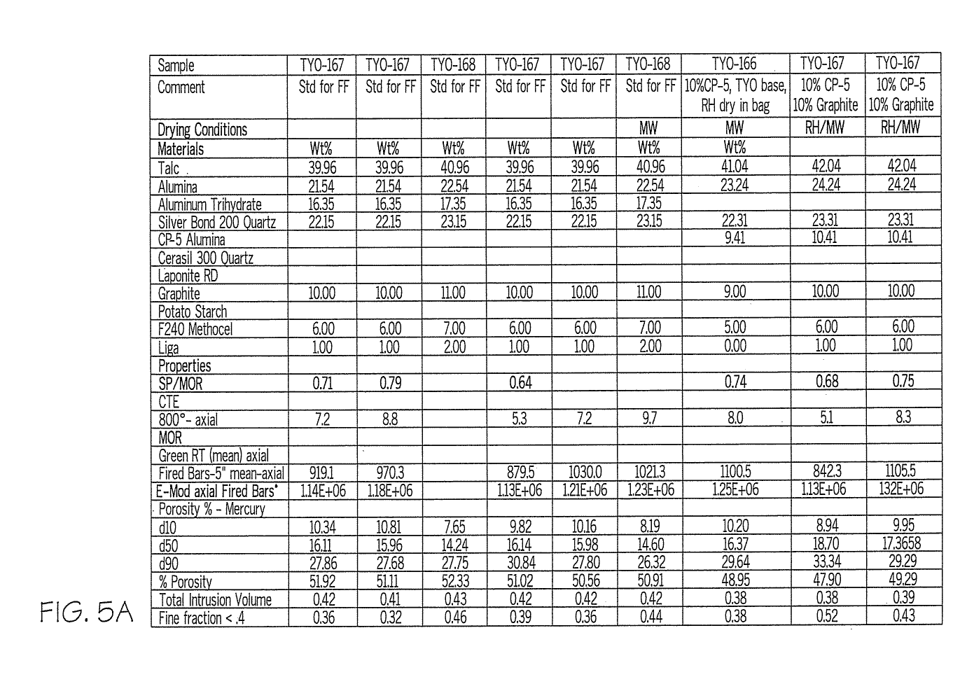

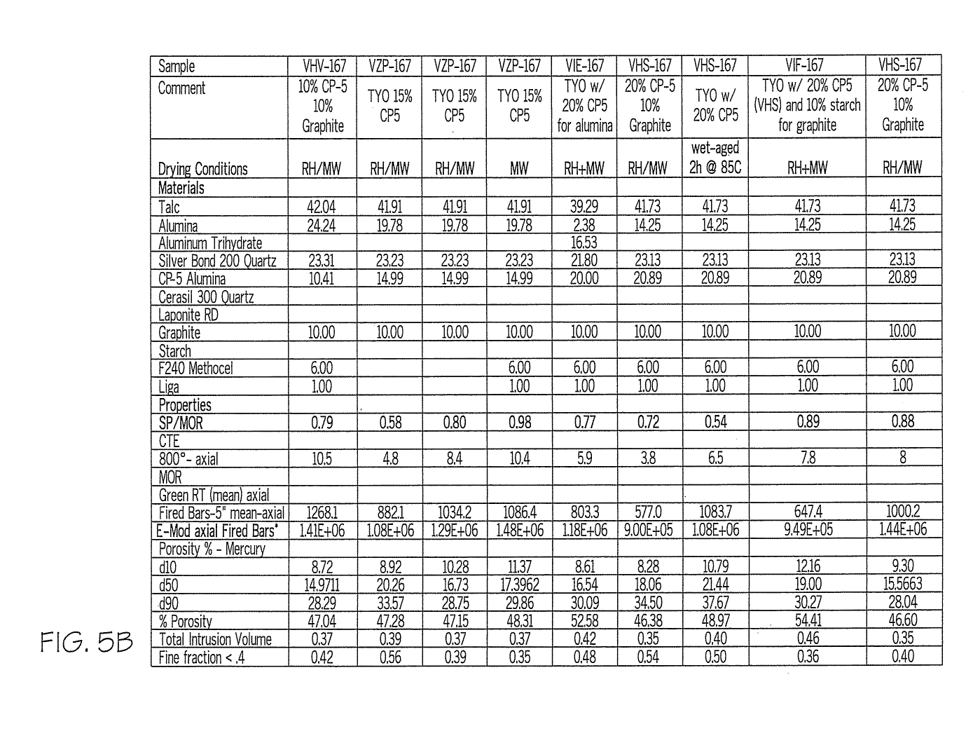

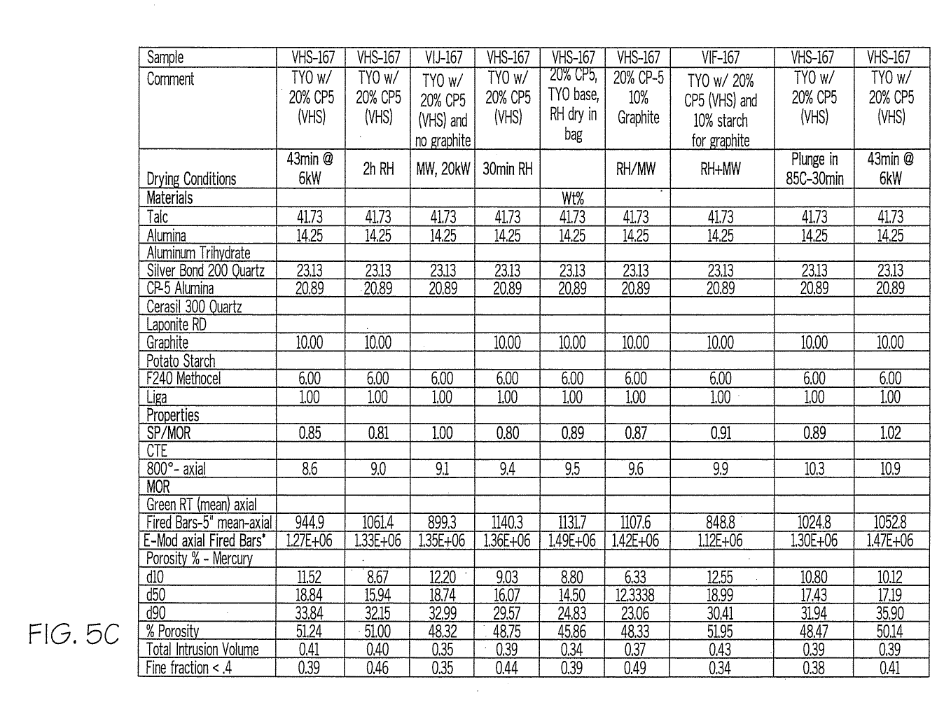

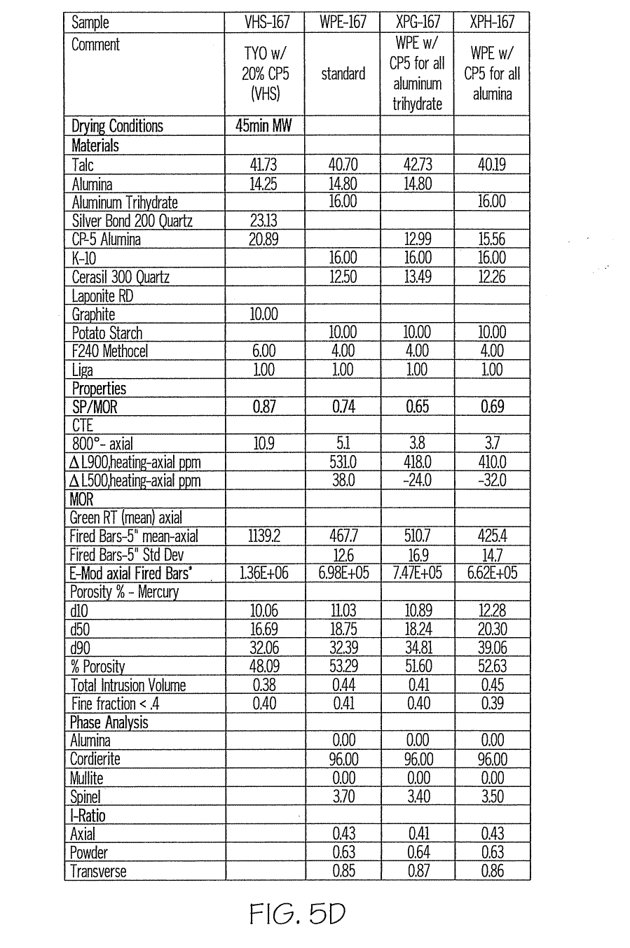

Hydration of CP5 compositions occurred with initial low-power microwave drying, as shown in FIG. 4. Hydration was reflected in the increased fired strength of the composition. This low-power microwave drying yielded characteristics that affect the final fired strength as shown. Table 2 and FIG. 5 show some of the physical properties of large dimension fired honeycombs comprising varying amounts of CP5 and different drying conditions as compared to the standard TYO. The properties were comparable to the standard TYO under the similar firing conditions.

TABLE 2

| | Sample | | | | | | |
|---|---|---|---|---|---|---|---|
| | 20% CP5 | | | | | | |
| | Drying Conditions | | | | | | |
| | 20 min | 43 min | 10 min | 10 min | 20 min | 43 min | |
| Porosity | 10 kW | 6 kW | 20 kW | 20 kW | 10 kW | 6 kW | TYO |
| D₁₀ | 11.42 | 11.52 | 13.44 | 10.92 | 10.55 | 10.12 | 10.04 |
| D₅₀ | 18.56 | 18.84 | 19.66 | 18.56 | 17.84 | 17.19 | 16.57 |
| D₉₀ | 31.30 | 33.84 | 36.01 | 32.05 | 33.33 | 35.90 | 35.52 |
| % Porosity | 50.39 | 51.24 | 51.29 | 49.58 | 49.78 | 50.14 | 49.48 |
| Intrusion volume (total) | 0.41 | 0.41 | 0.40 | 0.39 | 0.39 | 0.39 | 0.40 |
| Fine Fraction | 0.38 | 0.39 | 0.32 | 0.41 | 0.41 | 0.41 | 0.39 |

### Example 4

### Effect of CP5 on Shrinkage and Thermal Gradients of Cordierite Compositions

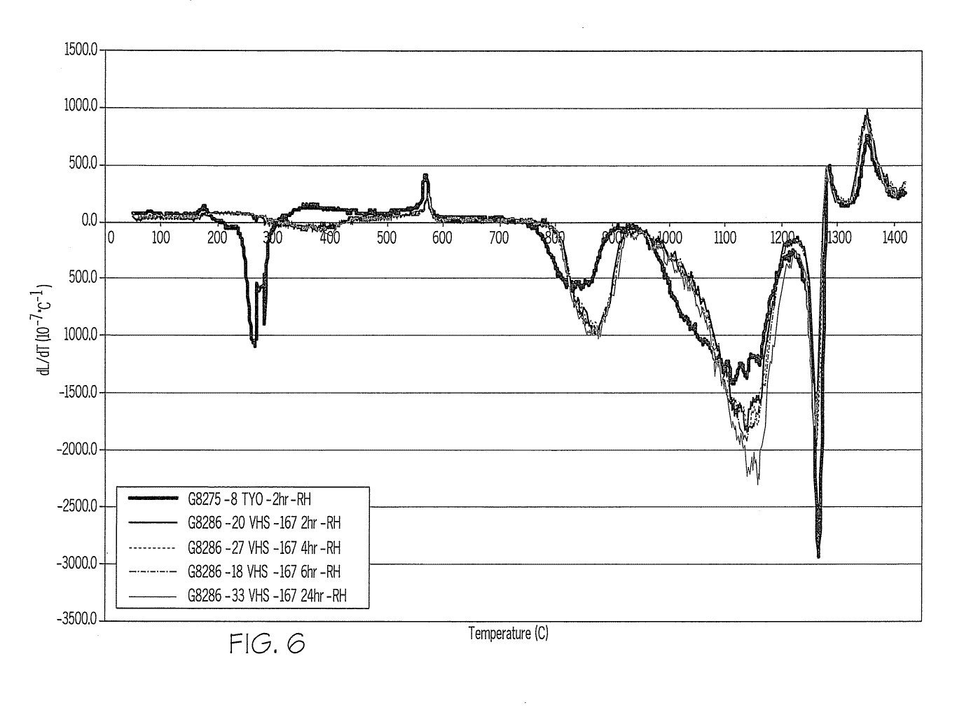

The addition of CP5 eliminated shrinkage at low temperatures during the firing of the honeycombs as shown by dilatometry of green honeycombs in FIG. 6. The VHS parts were hydrated in a humidity oven for 2 hr, 4 hr, 6 hr, and 24 hr. There was significant shrinkage in the control sample (TYO) between 200° C. and 300° C. as shown by the inverted peak of dilatometry curve in FIG. 6. This is followed by an expansion between 300° C. and 400° C. In contrast, all of the CP5 samples show no significant shrinkage or expansion in the same temperature range as evidenced by the relatively flat line. Eliminating the shrinkage event at low temperatures is believed to help reduce the stress on the honeycomb and decrease the chances for cracks forming.

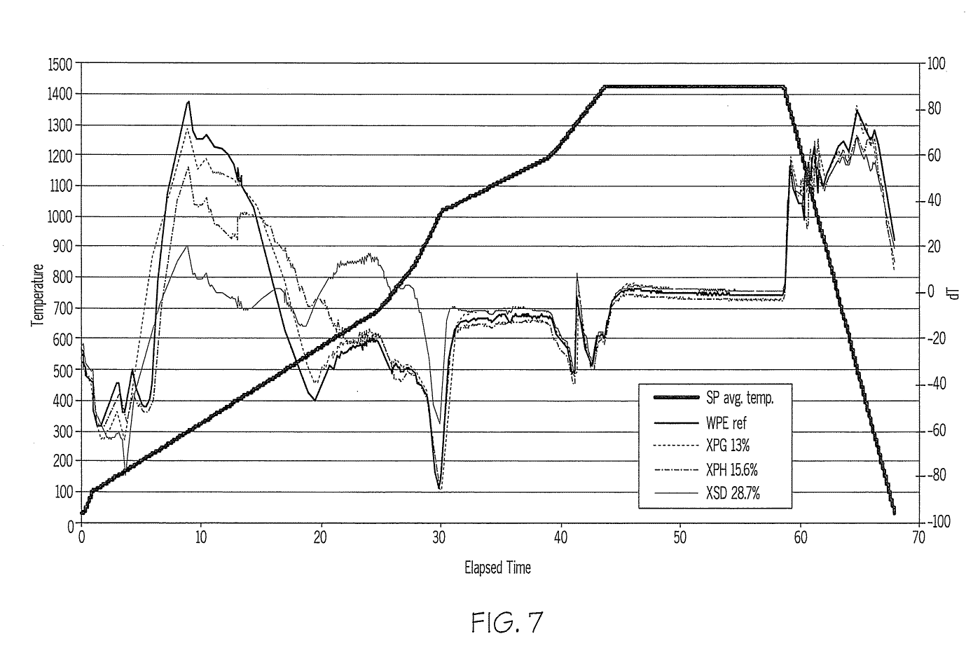

Another advantage of CP5 additions to cordierite honeycombs was the reduction of thermal gradients within parts during firing. FIG. 7 illustrates the impact of increasing additions of CP5 (13 wt %, 15.6 wt %, and 28.7 wt %) on delta T (ΔT) during firing, compared to the reference composition, WPE, containing no CP5. With increasing CP5, there is less change in the thermal gradient of the cordierite composition up to about 800° C. The addition of CP5 in these compositions also reduced the coefficient of thermal expansion (CTE) and improved the thermal shock parameter (SP/MOR) compared to the reference, as shown in FIG. 5.

The disclosure has been described with reference to various specific embodiments and techniques. However, many variations and modifications are possible while remaining within the spirit and scope of the claimed invention.

What is claimed is:

1. A cordierite batch composition comprising:
inorganic cordierite-forming ingredients comprising a hydratable alumina in an amount of from about 0.1 wt % to about 50 wt % based on the total weight of the inorganic cordierite-forming ingredients.

2. The composition of claim 1 wherein the hydratable alumina is from about 10 wt % to about 30 wt % based the total weight of the inorganic cordierite-forming ingredients.

3. The composition of claim 1 wherein the hydratable alumina comprises at least one of rho-alumina, gamma-alumina, eta-alumina, delta-alumina, kappa-alumina, or combinations thereof.

4. The composition of claim 1 wherein the inorganic cordierite-forming ingredients comprise hydratable alumina in from about 10 wt % to about 30 wt %, and alpha-alumina, aluminum trihydrate, or a mixture thereof, in from about 30 wt % to about 10 wt % based on the total weight of the inorganic cordierite-forming ingredients.

5. The composition of claim 1 wherein the inorganic cordierite-forming ingredients comprise hydratable alumina in from about 10 wt % to about 30 wt %, and alpha-alumina, aluminum trihydrate, or a mixture thereof, wherein the total amount of alpha-alumina, aluminum trihydrate, hydratable alumina, or a mixture thereof, is from less than about 50 wt % based on the total weight of the inorganic cordierite-forming ingredients.

6. The composition of claim 1 further comprising an organic binder and an aqueous solvent.

7. The composition of claim 1 further comprising an oil, an emulsifier, a surfactant, a lubricant, or combinations thereof.

8. The composition of claim 1 further comprising at least one pore forming agent.

9. A porous ceramic article formed by firing the composition of claim 1.

10. A method of producing a ceramic article comprised of porous cordierite, the method comprising:
mixing the inorganic cordierite-forming ingredients of claim 1, a binder, and a solvent to form a batch;
forming the batch into a green body;
drying the green body at a first time and temperature and then a second temperature; and
firing the dried green body to produce the porous cordierite.

11. The method of claim 10 wherein drying at the first time and temperature is less than about 60 minutes at less than about 100° C., and drying at the second temperature is from about 200° C. to about 1,200° C., until the green body is from about 70% to about 80% dry.

12. The method of claim 10 wherein the hydratable alumina is from about 10 wt % to about 30 wt % based on the total weight of the inorganic cordierite-forming ingredients.

13. The method of claim 10 wherein the hydratable alumina comprises at least one of a rho-alumina, gamma-alumina, eta-alumina, delta-alumina, kappa-alumina, or combinations thereof.

14. The method of claim 10 wherein the binder is organic, the solvent is aqueous, and the drying is accomplished with an electromagnetic device for a time and with a power sufficient to cause the hydration of the hydratable alumina by the aqueous solvent.

15. The method of claim 14 wherein the electromagnetic device is a microwave source.

16. The method of claim 15 wherein the drying comprises irradiating the green body at a power of less than about 100 kW for less than about 6 hours.

17. The method of claim 15 wherein the drying comprises irradiating the green body at a power of from about 2 kW to about 25 kW for less than about 1 hour.

18. The method of claim 17 further comprising drying the green body at a power greater than about 100 kW until the green body is from about 70% to about 80% dry.

19. A porous cordierite ceramic article formed by the method of claim 10.
